(19) United States
(12) Patent Application Publication
(10) Pub. No.: US 2026/0177768 A1
(43) Pub. Date: Jun. 25, 2026

(54) OPTICAL FIBER ARRAY ASSEMBLY, A SIGNAL RECEIVING STRUCTURE AND AN OPTICAL MODULE COMPRISING THE SAME

(71) Applicant: Source Photonics (Chengdu) Co., Ltd., Chengdu (CN)

(72) Inventors: Dong MOU, Chengdu (CN); Lihui ZHUANG, Chengdu (CN); Xin SHUAI, Chengdu (CN); Jieling HE, Chengdu (CN); Youwen HU, Chengdu (CN)

(21) Appl. No.: 19/235,625

(22) Filed: Jun. 12, 2025

Related U.S. Application Data
(63) Continuation of application No. PCT/CN2024/141066, filed on Dec. 20, 2024.

(51) Int. Cl. G02B 6/42

(52) U.S. Cl. CPC G02B 6/4243; G02B 6/4204; G02B 6/4257; G02B 6/428

(57) ABSTRACT

An optical fiber array assembly, signal receiving structure and optical module including an optical fiber array module and a lens module are disclosed. The optical fiber array module includes a base and optical fibers on one side of the base. The optical fibers each have an end configured as an inclined plane. The lens module is on the opposite side of the base, near the ends of the optical fibers. The inclined planes reflect optical signals in the optical fibers through the base and into the lens module. The lens module focuses the optical signals on one or more light receiving chips. The assembly provides a small light spot with higher coupling efficiency and increases the position window of all channels of the optical fiber array module and the product yield, while reducing process difficulty and the probability of collisions between the optical fiber array module and the light receiving chips.

### CROSS REFERENCE TO RELATED APPLICATION(S)

This application is a continuation of International Appl. No. PCT/CN2024/141066, filed Dec. 20, 2024, incorporated herein by reference.

### FIELD OF THE INVENTION

The present invention generally relates to the field of optical communication equipment, particularly, an optical fiber array assembly, a signal receiving structure and an optical module comprising the same.

### DISCUSSION OF THE BACKGROUND

Optical modules are important devices in optical communication technology, and are mainly used to realize the mutual conversion between optical and electric signals. Conventional optical modules are generally configured with a base, a top cover, a PCBA board (circuit board), an optical fiber interface, and a receiver (RX) and/or a transmitter (TX), where the receiver is mainly configured to implement optical-electrical conversion, and the transmitter is mainly configured to implement electrical-optical conversion. The process used to package the optical module is typically COB (chip on board), the main purpose of which is to optically couple the relevant components with the PCBA board, and finally realize the function of optical-electrical/electrical-optical conversion of optical signals.

In the receiver (RX) of a conventional optical module, optical signal transmission is generally realized by directly coupling light from an optical fiber to a light receiving chip (such as a photoelectric detector [PD]). A specific implementation structure is shown in FIGS. 1 and 2. The optical device 1′ at the receiving end includes an array of optical fibers 14, and the light receiving chip 4 includes a photoelectric detector. The optical device 1′ further comprises a first clamping part (or base) 12, a second clamping part (or cover plate) 11, and at least two optical fibers 14. Each optical fiber 13 is in an array and is clamped between the first clamping part 12 and the second clamping part 11 to fix the optical fiber 14 in a groove or slot 13 in the second clamping part 11. As shown in FIGS. 1-2, the second clamping part 11 does not cover the angled face (or total reflection slope) 141 at the end of the optical fiber 14, in part so that the photoelectric detector 4 can be closer to the optical fiber 14, and in part so that the transmission direction of the optical signal in the optical fiber 14 can change at the total reflection slope 141. The photodetector 4 and the second clamping part 12 may be on the same side or adjacent sides of the first clamping part 12, and the photodetector 4 corresponds to the end of the optical fiber 14, as shown in FIGS. 1 and 2, so that the optical signal reflected by the total reflection slope 141 can be smoothly coupled to the photodetector 4.

TABLE 1
Relationship between spot diameter and spacing between
photodetector and fiber array module profile

| Distance between the photodetector and | |
|---|---|
| the outline of the fiber array module (μm) | Maximum spot diameter (μm) |
| 0 | 11.9 |
| 10 | 14.74 |
| 20 | 17.56 |
| 30 | 20.4 |

However, the conventional design has the following disadvantages: first, because the light emitted from the optical fiber 14 is divergent, in order to have high efficiency of coupling to the photoelectric detector 4 (typically, the diameter of a high-speed PD is 16 μm or less), it is necessary to ensure that the diameter of the light spot and/or light beam impinging on the photoelectric detector 4 is less than 16 μm. As shown in Table 1, as the distance between the photoelectric detector 4 and the optical fibers 14 in the optical fiber array module is smaller, the diameter of the light spot on the surface of the photoelectric detector is smaller. As a result, the photoelectric detector 4 needs to be close to the optical fiber 14 in the optical fiber array module to ensure that the light spot diameter is less than 16 μm. This requires clear image recognition to determine and control the position of the optical fiber array module during coupling, which leads to very high requirements for the process of this design, and in the actual assembly process, although there is the assistance of image recognition, the optical fiber array module still easily contacts the photoelectric detector 4, causing damage to the optical fiber(s) 14 and/or the photoelectric detector 4, which greatly affects the product yield.

Second, in practice, the light spot size of the light beam impinging on the photodetector 4 is large, resulting in low coupling efficiency, and the optical fiber array module must also comply with various manufacturing and/or placement tolerances, resulting in a narrow coupling position window of the optical fiber array module that couples all channels to achieve high coupling efficiency, which further increases the difficulty of the process.

### SUMMARY OF THE INVENTION

In order to solve the above technical problems, a first aspect of the present invention provides an optical fiber array assembly, which has the advantages of a simple process and higher coupling efficiency, and which not only widens the coupling position window of the optical fiber array module, but also greatly reduces the probability of collision between the optical fiber array module and the photoelectric detector, and effectively improves the product yield. The main idea is as follows.

An optical fiber array assembly in accordance with one aspect of the present invention comprises an optical fiber array module and a lens module that may be adapted to the optical fiber array module, wherein the optical fiber array module comprises a base and at least two optical fibers in an array on one side of the base. Each of the optical fibers has an end configured as an inclined plane. The lens module is on an opposite side of the base in a location corresponding to the ends of the optical fibers. The optical signals transmitted through the optical fibers are reflected by the ends of the optical fibers through the base and into the lens module (e.g., after passing through the base). The lens module is configured to focus the optical signal on one or more light receiving chips. In this solution, the end of the optical fiber is constructed as an inclined surface to form a total reflection surface, and the total reflection surface changes the transmission direction of the optical signal by placing or inserting the optical fiber in the base and placing or setting the lens module on the base, and positioning the lens module in a location corresponding to the end of the optical fiber (i.e., the location where the reflected light signals emerge from the base), so that the optical fibers and the lens module are respectively located in and on the base to cooperate with each other. In this manner, the light beams reflected from the total reflection surfaces at the end of the optical fibers can pass through the base and enter the lens module, so as to realize smooth and stable transmission of optical signals. In a second aspect, since part of the base is spaced between the optical fibers and the lens module, during production and manufacturing, lens modules with different focal lengths can be adapted by controlling or changing the thickness of the base, or using lenses with different shapes or properties, so as to meet application requirements (e.g., of lens modules with different focal lengths). The convergence speed and convergence distance of the light beam exiting from the lens module can also be controlled or adjusted by controlling or changing the thickness of the base, which can not only reduce the distance between the lens module and the light receiving chip as much as possible (e.g., on the basis of ensuring the light spot diameter), but can also help reduce the overall volume of the optical signal receiving structure and the light module, and can obtain a light spot with a smaller diameter, which can significantly improve the coupling efficiency. In addition, the coupling position window of the optical fiber array module with high coupling efficiency can be increased for all channels, thus greatly reducing the process difficulty. In a third aspect, since the base is spaced between the optical fibers and the lens module (e.g., the optical fibers are in the base), in parts of the manufacturing and/or assembly process, foreign objects can be prevented from contacting and damaging the fragile optical fibers, thereby helping to protect the optical fibers and improve the product yield. By configuring the lens module, the lens module focuses the light beam, so that the light beam can converge on the light receiving chip. In this way, sufficient spacing can be reserved between the lens module and the light receiving chip during assembly. On the one hand, the light receiving chip does not need to contact or be within 10-12 μm of the lens module, and the light receiving chip is also relatively far away from the optical fiber, thus greatly reducing the probability of collision between the optical fiber array module and photoelectric detector. On the other hand, in the assembly process, there is no need to determine and/or control the position of the fiber array module through image recognition, simplifying the process.

The chip can greatly reduce the diameter of the light spot impinging on the light receiving chip, not only can further improve the coupling efficiency, but also can increase the coupling position window of the optical fiber array module, effectively widening the coupling efficiency of all channels and reducing the difficulty of the process.

Preferably, the lens module is connected to the base with an adhesive. In this solution, the lens module and the base are connected by the adhesive, so that the lens module can be stably fixed to the base to ensure that the distance between the lens module and the optical fiber does not change, which is beneficial to ensure the stable transmission of optical signals. In addition, the gap between the lens module and the base can be eliminated by the adhesive, which avoids the problem of loss of optical signal transmittance due to the interface(s) between the optical fiber array module and the air, and improves optical signal transmittance.

Preferably, the adhesive is a refractive index matching adhesive (e.g., an adhesive having a refractive index that matches, or is within 5-10% of, the refractive index of one or both components connected to each other by the adhesive).

Preferably, the base (or at least the part of the base between a lowermost point of the optical fibers and the lens module or adhesive) has a thickness of 0.1 mm to 1.2 mm. It is beneficial to obtain a light spot with a smaller diameter in a smaller overall volume, and a relatively small thickness of the base (e.g., between the optical fibers and the lens module or adhesive) can effectively improve the coupling efficiency.

A further aspect of the present invention solve one or more problems related to light transmission efficiency. For example, the surface of the lens module facing the base is a light receiving surface, and the light receiving surface may include a first anti-reflection film.

The first anti-reflection film may be on the light receiving surface of the lens module, so that the first anti-reflection film is located between the adhesive and the lens module, and any reduction in the light passing efficiency due to the large difference in refractive index between the adhesive and the lens module can be solved by the first anti-reflection film, which can effectively improve the transmittance and light passing efficiency of the optical signal.

In yet another aspect of the present invention, one or more problems related to light transmission efficiency is further improved. For example, the surface of the lens module away from the base is a light emitting surface, and the light emitting surface may include a second anti-reflection film. The second anti-reflection film is on the light-emitting surface of the lens module, so that the second anti-reflection film is located between the lens module and the photoelectric detector (or, perhaps more specifically, the air between the lens module and the photoelectric detector). The second anti-reflection film solves a problem in which the light-passing efficiency is greatly reduced due to the large refractive index difference between the lens module and the air, and can effectively improve the transmittance and the light transmission efficiency of the optical signal.

In order to further improve the light transmission efficiency, the surface of the base facing the lens module may include a third anti-reflection film. The third anti-reflection film is on the surface of the base, so that the third anti-reflection film is located between the base and the adhesive, and any reduction in the light transmission efficiency due to the large refractive index difference between the base and the adhesive is solved by the third anti-reflection film, which can effectively improve the transmittance and light transmission efficiency of the optical signal.

A fourth aspect of the present invention solves one or more problems related to reducing the volume and the cost of the optical fiber array assembly. For example, the lens module may include a lens comprising silicon material (e.g., a silicone, silica, a silicate glass, etc.). Lenses made of such silicon materials tend to have a high refractive index, so that the light beam is more easily focused or converged, the focal length of the lens module can be shortened, and the whole optical fiber array module can be thinner (e.g., shortened along the vertical or longitudinal direction). Consequently, the overall height of the optical fiber array module can be maintained within specifications or other predetermined dimensions, which is beneficial to reduce the volume and the cost of the optical fiber array module.

A fifth aspect of the present invention solves a problem in the process of manufacturing and using the conventional optical fiber array module, in which optical fiber edge collapse (e.g., chipping or other damage) easily causes product yield losses. For example, the optical fiber array module further includes a cover plate, the cover plate is connected to the base, and the optical fibers are secured between the cover plate and the base (e.g., at least two sides of the end of each optical fiber may be clamped between the cover plate and the base). Not only can the optical fiber be restrained more simply, stably and firmly, but also the end of the optical fiber can be secured by the cover plate and the base (e.g., clamped inside the cover plate and the base), so that the optical fibers are protected, especially the fragile end of the optical fibers, which can greatly reduce the risk of optical fiber edge collapse in the process of production and use, improve the yield of the product, and effectively prevent the optical fiber from being damaged, which is beneficial to improve the service life of the optical receiver.

Further, the cover plate and/or the base may be configured with at least two grooves to accommodate (e.g., secure the position of) the optical fibers. The optical fibers may be respectively in the grooves (e.g., each optical fiber may be in a corresponding unique groove), and the grooves may further contain a refractive index matching adhesive (e.g., filling part or all of the space in the groove not occupied by the optical fiber). On the one hand, the refractive index matching adhesive can fix the optical fiber more stably and firmly in the groove. On the other hand, the refractive index matching adhesive can fill some or all of the gap(s) in the groove, and because the refractive index of the refractive index matching adhesive can match the optical fiber and the base, the loss of the optical signal entering the base from the optical fiber is smaller, and the transmittance is higher. Thus, in one embodiment, the refractive index matching adhesive completely fills the space in the groove between the optical fiber and the base.

Preferably, the groove is a V-shaped groove.

Preferably, one end of the base is configured as an inclined plane, and one end of the cover plate is configured as an inclined plane. For example, the inclined planes of the ends of the base and the cover plate may have the same angle relative to the plane of the interface between the base and the cover plate, and this angle may also be the same as the angle of the total reflection surface at the end of the optical fibers.

A sixth aspect of the present invention solves a problem with ensuring and improving the coupling efficiency. For example, the optical fiber array module may further include a cushion block to which the base is connected. The cushion block and the lens module may be on the same side or surface of the base, and the distance between the lens module and the light receiving chip is controlled by the cushion block (e.g., the height or thickness of the cushion block). By configuring the cushion block and arranging the cushion block and the lens module on the same side or surface of the base, the cushion block can stably support the base, and the thickness of the cushion block, which is controllable, can guarantee spacing between the lens module and the light receiving chip. The height or thickness of the cushion block thus ensures that the distance between the lens module and the light-receiving chip can meet design requirements or specifications, further ensuring that the diameter of the light spot meets specifications or requirements (e.g., is below a maximum allowable diameter), which is conducive to obtaining higher coupling efficiency.

Preferably, the cushion block has a thickness of 0.3 mm to 2.15 mm. While ensuring that the distance between the lens module and the light receiving chip can meet design requirements or specifications, the diameter of the light spot at the light receiving chip can be below a maximum allowable diameter, leading to higher coupling efficiency.

Preferably, the cushion block is connected to the base by an adhesive (e.g., a non-refractive index matching adhesive).

An optical signal receiving structure may include the present optical fiber array assembly, and may further include a light receiving chip and a supporting component. The light receiving chip is on the supporting component in a position or location that corresponds to (e.g., receives the optical signal from) the lens module, and there is a spacing between the lens module and the light receiving chip. In this solution, when the light receiving chip receives the optical signal from the lens module, and the distance between the lens module and the light receiving chip matches or corresponds to the focal length of the lens module, the light beam (optical signal) from the lens module converges on the light receiving chip, which can greatly reduce the diameter of the light spot impinging on the light receiving chip, improve the coupling efficiency, and increase or widen the coupling position window of the optical fiber array module with high coupling efficiency, effectively reducing the difficulty of the manufacturing/assembly process. At the same time, in the assembly process, on the one hand, the light receiving chip does not need to directly contact the lens module, and the light receiving chip is also relatively distant from the optical fiber, which greatly reduces the probability of collision between the optical fiber array module and the photoelectric detection and effectively improves the product yield. On the other hand, there is no need to determine or control the position of the optical fiber array module through clear image recognition, which simplifies the manufacturing/assembly process.

Preferably, the distance between the lens module and the light receiving chip is 0.1 mm to 2 mm. Such distances are beneficial to better realize the above-mentioned technical effects.

Further, the optical fiber array assembly may further include a cushion block, wherein the base is on the cushion block, the cushion block is on the supporting component, and the distance between the lens module and the light receiving chip is controlled by the cushion block (e.g., its height or thickness). In this solution, the light receiving chip is on the supporting component, the base (and, thus, the optical fiber array) is also on the supporting component through the cushion block, and the lens module in the optical fiber array assembly is in a position or location that corresponds to the light receiving chip, in which the cushion block stably supports the optical fiber array assembly, and controls and ensures the distance between the lens module and the light receiving chip (e.g., by controlling the thickness of the cushion block, thereby ensuring that the distance between the lens module and the light receiving chip meets specifications or design requirements, and the size of the light spot on the light receiving chip from the lens module is below a maximum allowable diameter, thereby facilitating and/or obtaining a higher coupling efficiency.

Preferably, the light receiving chip comprises a photodetector.

Preferably, the supporting component comprises a PCB board or a substrate (e.g., a mechanical substrate).

An optical module may include the present optical fiber array assembly or the present optical signal receiving structure.

Further, a housing may be further included that provides an assembly space, and the optical fiber array assembly or the optical signal receiving structure may be in the assembly space.

Preferably, the housing includes a housing base and a top plate. The top plate is detachable from the base, and the assembly space is between the top plate and the housing base.

Preferably, an optical fiber interface is at one end of the housing, and the optical fiber array assembly may be connected to the optical fiber interface through the optical fibers, which may transmit an external (e.g., received) optical signal to the optical receiving chip in the optical module through the optical fiber interface.

Compared with the prior art, the present optical fiber array assembly, optical signal receiving structure and optical module can reduce the spot size or diameter of the optical signal at the light receiving chip/photodetector, has higher coupling efficiency than the background optical fiber array assembly and optical signal receiving structure, and enables all channels in the optical fiber array to achieve high coupling efficiency. The coupling position window of the present optical fiber array assembly and optical module is wider than the background optical fiber array assembly and optical module, which effectively reduces the difficulty of the manufacturing/assembly process. On the other hand, the probability of collision between the fiber array module and the light receiving chip is greatly reduced, and product yield is effectively improved.

### BRIEF DESCRIPTION OF THE DRAWINGS

FIG. 1 is a structural schematic diagram showing a conventional optical fiber array module.

FIG. 2 is a schematic structural diagram showing a conventional optical fiber coupling solution.

FIG. 3 is a schematic structural diagram showing an optical fiber array assembly according to Embodiment 1 of the present disclosure.

FIG. 4 is a schematic perspective structural diagram showing the optical fiber array assembly according to Embodiment 1 of the present disclosure.

FIG. 5 is a schematic perspective diagram showing the structure of another optical fiber array assembly provided in Embodiment 1 of the present disclosure.

FIG. 6 is a schematic structural cross-sectional view of the optical fiber array assembly shown in FIG. 3 for optical fiber coupling.

FIG. 7 is a partial structural schematic diagram of the optical fiber array assembly provided in Embodiment 2 of the present disclosure.

FIG. 8 is a partial structural schematic diagram of another optical fiber array assembly provided in Embodiment 2 of the present disclosure.

FIG. 9 is a schematic structural diagram of the signal receiving structure according to Embodiment 3 of the present disclosure.

FIG. 10 is a graph comparing the coupling ratios of an optical fiber array assembly in accordance with an embodiment of the present disclosure and a conventional optical fiber array assembly.

The components identified by the numbers in the figures include:
Optical fiber array module 1, base 11, cover plate 12, groove 13, optical fiber 14, inclined surface 141, third anti-reflection film 15, lens module 2, spherical surface 21, first anti-reflection film 22, second anti-reflection film 23, cushion block 3, light receiving chip 4, adhesive 5, and supporting member 6.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following description of the present invention, numerous specific details are set forth in order to provide a thorough understanding of the present invention. However, it will be readily apparent to one skilled in the art that the present invention may be practiced without these specific details.

### Embodiment 1

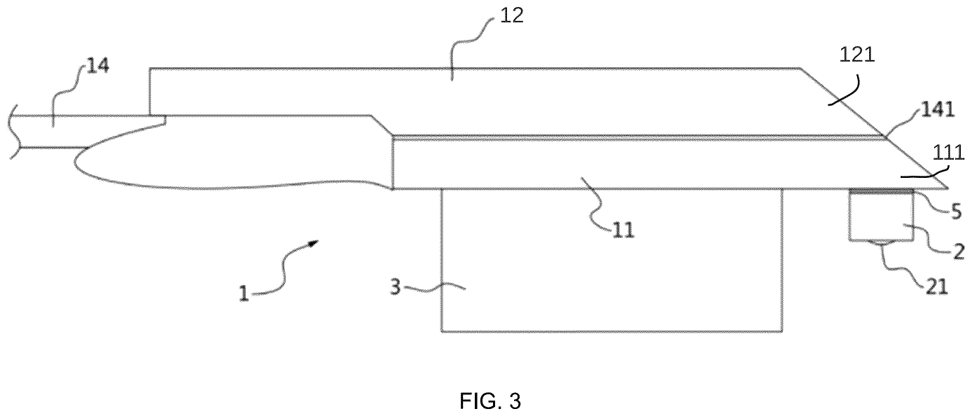

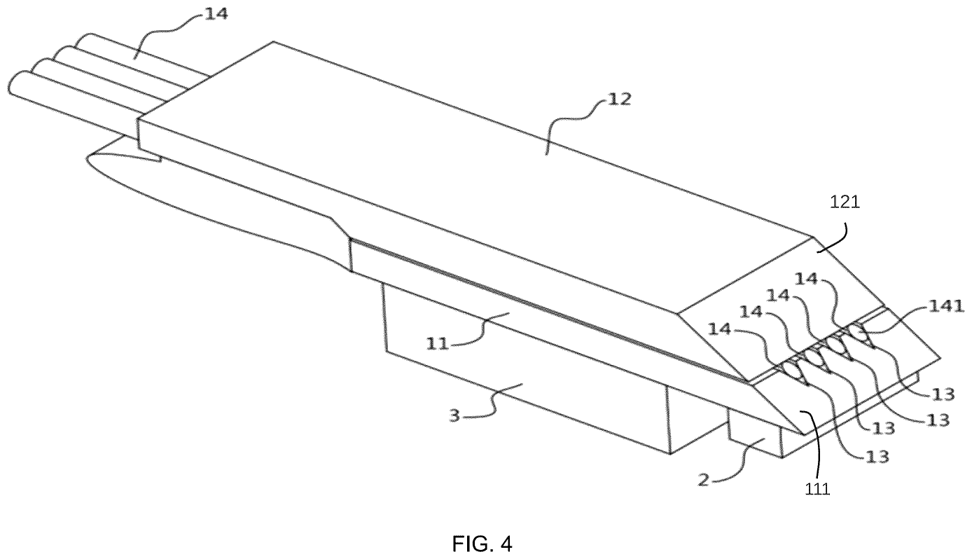

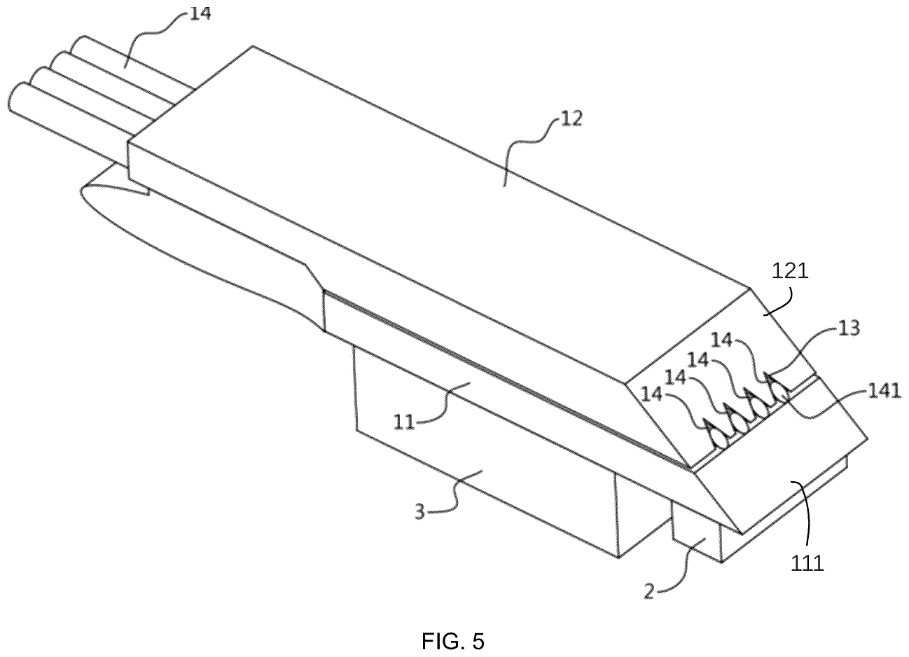

This embodiment provides an optical fiber array assembly, including an optical fiber array module 1 and a lens module 2 adapted (e.g., secured or affixed) to the optical fiber array module 1. As shown in FIGS. 3-5, the optical fiber array module 1 includes a base 11 and one or more optical fibers 14. In an implementation, the number of the optical fibers 14 may be one, two, three, four, or the like according to actual requirements. In a preferred embodiment, at least two optical fibers 14 are in the optical fiber array module 1, and each optical fiber 14 is in or on the base 11 in an array. For example, in the embodiment shown in FIGS. 3-5, four optical fibers 14 are in the optical fiber array module 1. As shown in FIGS. 4 and 5, four optical fibers 14 are on the base 11 in which adjacent optical fibers 14 are spaced from each other by an array interval, respectively.

As shown in FIGS. 3 to 5, an end of each optical fiber 14 is configured as an inclined surface 141, and an angle of the inclined surface 141 may form a total reflection surface at the end of the optical fiber 14, which changes a transmission direction of the optical signal in the optical fiber (e.g., to reflect it towards the lens module 2). The optical fibers 14 in the optical fiber array module 1 may have multiple embodiments. For example, in one embodiment, the optical fiber 14 may be fixed to the upper surface of the base 11 by adhesive. For example, in another embodiment, the upper surface of the base 11 may include grooves 13 that accommodate the optical fibers 14, in which case the number of the grooves 13 is the same as that of the optical fibers 14, and the optical fibers 14 are respectively in the grooves 13, as shown in FIGS. 4 and 5. As the front end of the optical fiber 14 in the optical fiber array module 1 is thinned or otherwise formed into a total reflection inclined plane 141, which can be very fragile, the problem of edge chipping of the optical fiber 14 may easily occur during manufacturing and use, thereby causing yield loss. Therefore, in a further embodiment, the optical fiber array module 1 further includes a cover plate 12 adapted to the base 11. For example, the cover plate 12 may have a lowermost surface with length and width dimensions identical or substantially identical to length and width dimensions of an uppermost surface of the base 11. The cover plate 12 may be connected to the base 11, for example, by an adhesive, in which case the cover plate 12 may clamp the ends of the optical fibers 14 (e.g., containing the inclined surfaces 141) between the cover plate 12 and the base 11. For example, as shown in FIGS. 4 and 5, the entire front ends of the optical fibers 14 (e.g., other than inclined surfaces 141, which remain exposed to air) are clamped between the cover plate 12 and the base 11, so that the ends of the optical fiber 14 can be clamped inside the cover plate 12 and the base 11, and the entire optical fiber 14 is protected, in particular, the fragile end of the optical fiber 14 at and adjacent to the inclined surface 141 can be effectively protected, which can greatly reduce the risk of chipping or damaging the edge of the optical fiber 14 during manufacturing and use, effectively improve the yield of the product, and effectively prevent the ends of the optical fibers 14 from being damaged, which is conducive to improving the service life. Thus, in one preferred embodiment, the optical fiber array module 1 comprises a cover plate 12 adapted to the base 11 and including grooves 13 to accommodate the optical fibers 14. As shown in FIG. 5, the number of the grooves 13 is the same as that of the optical fibers 14, and each optical fiber 14 is respectively in a corresponding and/or unique one of the grooves 13. The cover plate 12 is connected to the base 11, so that the optical fibers 14 are sandwiched between the cover plate 12 and the base 11, to achieve the purpose of constraining the optical fiber 14 more simply, stably and securely.

In various implementations, the grooves 13 (or the spaces in the grooves 13 not occupied by the optical fibers 14) can be preferentially filled with refractive index matching adhesive. On the one hand, the refractive index matching adhesive can fix the optical fiber 14 more stably and firmly in the groove 13. On the other hand, a refractive index matching adhesive in the gaps in the grooves 13 can have a refractive index matching that of the optical fiber 14 and/or the base 11 (or between the refractive indices of the optical fiber 14 and the base 11, such that the refractive index of the refractive index matching adhesive is within 5-7% of the refractive indices of each of the optical fiber 14 and the base 11), to decrease any loss of the optical signal entering the base 11 from the optical fiber 14 and increase the transmittance. In some implementations, the grooves 13 may preferably have a V-shape, as shown in FIGS. 4 and 5, and the part of the optical fiber 14 sandwiched between the cover plate 12 and the base 11 may include a core and a cladding covering the core. In implementation, the base 11 may be preferentially configured as a plate-like structure or a plate-like structure; and the cover plate 12 may also be preferentially configured as a plate-like structure, as shown in FIGS. 3-5. Both the base 11 and the cover plate 12 may preferably comprise a glass material.

In manufacturing, one end of the base 11 may have an inclined surface 111, and one end of the cover plate 12 may also have an inclined surface 121, as shown in FIGS. 3-5, and the angles of the inclined surfaces 111 and 121 (and, optionally, 141, all of which may be relative to the plane of the interface between the cover plate 12 and the base 11) may be the same.

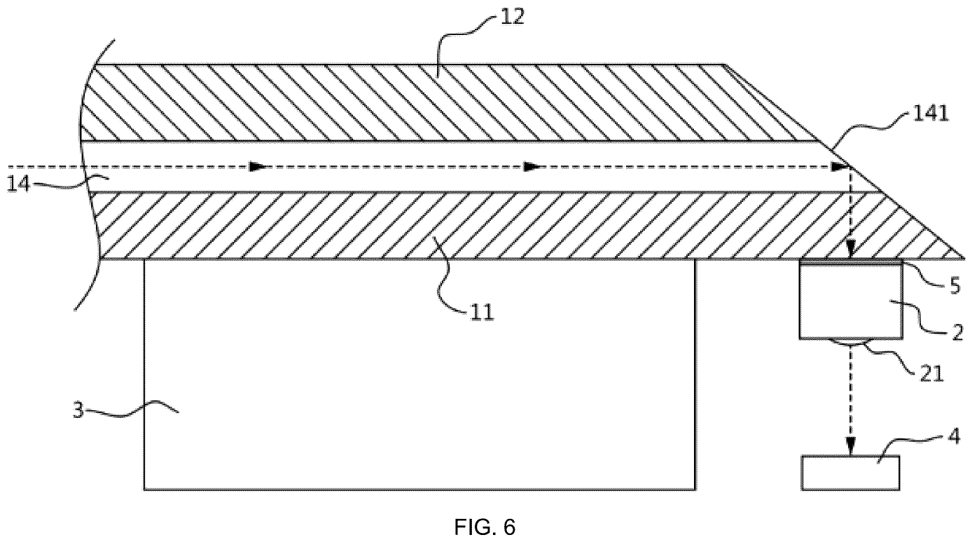

As shown in FIGS. 3-5, the lens module 2 is on an opposite side of the base 11 from the cover plate 12, and is in a position or location that corresponds to (e.g., is directly under) the end of the optical fiber 14. That is, the lens module 2 and the optical fiber 14 are respectively on opposite sides of the base 11. The number and position of the lenses in the lens module 2 are respectively adapted to (e.g., matching those of) the optical fibers 14, and the optical signals transmitted by the optical fibers 14 enter the base 11 after being reflected by the inclined planes 141 at the ends of the optical fibers 14. The optical signals pass through the base 11 and into the lens module 2, and specifically, the optical signal output by each optical fiber 14 may respectively enter a corresponding lens (see, e.g., FIG. 6). The lens module 2 has a focusing function, and the lens module 2 is mainly configured to converge or focus the optical signals onto the light receiving chip 4 (or the photodetector [s] thereof). In this implementation, the optical fibers 14 and the lens module 2 are located on opposite sides of the base 11 and cooperate with each other, and during production and manufacturing, lens modules 2 with different focal lengths can be adapted (e.g., for use with different components) by controlling or changing the thickness of the base 11, so as to meet design or application requirements of lens modules 2 with different focal lengths. The convergence speed and the convergence distance of the light beams exiting the lens module 2 can also be controlled or adjusted by controlling or changing the thickness of the base 11 (e.g., the thickness of the part of the base 11 between the inclined planes 141 and the lens module 2), because if the base 11 is too thin, the distance between the optical fiber 14 and the lens module 2 is too close, and the convergence distance of the light beam exiting the lens module 2 may greatly increase, which can lead to an unacceptable increase in the size of the entire optical fiber array assembly and the optical module. If the base 11 is too thick, the distance between the optical fibers 14 and the lens module 2 will be too large, and the increase in the size of the optical fiber array assembly and the optical module may be unacceptable. Therefore, the thickness of the base 11, particularly the spacing between the optical fibers 14 and the lens module 2, should be reasonably set. Generally, the thickness of the base 11 (e.g., providing the spacing between the optical fibers 14 and the lens module 2) can be configured according to the focal length of the lens module 2, to reduce the distance between the lens module 2 and the light receiving chip 4 as much as possible (e.g., by ensuring the maximum light spot diameter is below a threshold), which is conducive to reducing the overall volume of the optical signal receiving structure and the optical module, and to obtain a light spot with a relatively small diameter, which can significantly improve the coupling efficiency widen or increase the coupling position window of the optical fiber array module 1 with high coupling efficiency of all channels, and greatly reduce the process difficulty. In practical applications, since the light beam after passing through the lens module 2 converges or is focused on the light receiving chip 4, in this way, sufficient spacing can be reserved between the lens module 2 and the light receiving chip 4 during assembly. On the one hand, the light receiving chip 4 does not contact the lens module 2 and is also relatively distant from the optical fiber 14. Therefore, the probability of collision between the optical fiber array module 1 and the photoelectric detector is greatly reduced, and the product yield is effectively improved. On the other hand, in the assembly process, it is not necessary to determine and/or control the position of the optical fiber array module 1 through clear image recognition, which simplifies the process. In addition, the lens module 2 focuses the light beam on the light receiving chip 4, which can greatly reduce the diameter of the light spot impinging on the light receiving chip 4, further improve the coupling efficiency, and increase the coupling position window of the optical fiber array module 1, effectively reducing the process difficulty. The coupling position window of the optical fiber array module 1 is explained in Embodiment 3, and will not be repeated here.

In implementation, the thickness of the base 11 (or the spacing between the optical fibers 14 and the lens module 2) may preferably be 0.1 mm to 1.2 mm (for example, 0.3 mm, 0.4 mm, 0.5 mm, 0.6 mm, etc.), which is beneficial to achieve a better effect.

In various implementations, each lens 21 in the lens module 2 may preferentially comprise a spherical lens, and the lens module 2 may be an integrally-formed component, as shown in FIGS. 3 and 6. That is, the lens module 2 is constructed with a convex, partially spherical surface 21. The spherical surface 21 emits light (e.g., the optical signal reflected by the corresponding inclined plane 141 and passing through the base 11), and the material of the lens module 2 may be determined according to actual or predetermined requirements. In this embodiment, the lens module 2 may comprise a silicon material (e.g., a silicone that is substantially transparent to the wavelength[s] of the optical signal and/or that has dimensions and/or a refractive index providing a predetermined or desired focal length). For example, the refractive index of silicone lenses is typically relatively high, so that the light beam is more easily focused or converged, and the focal length of the lens module 2 is relatively short. As a result, the entire optical fiber array module 1 can be made shorter along the vertical direction (longitudinal direction), and the overall height of the optical fiber array module 1 will not be too high, which is not only beneficial to reduce the volume, but also lower the cost.

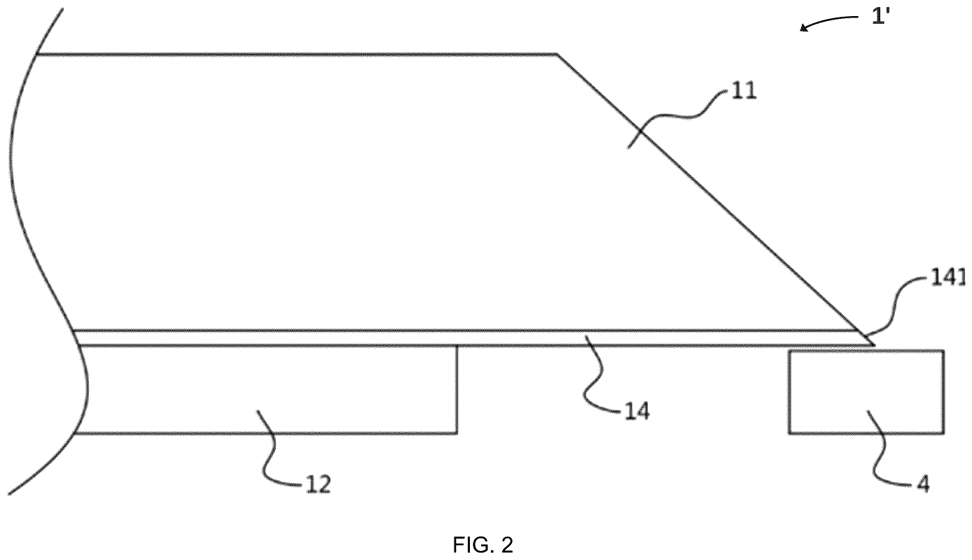

In the prior art, the optical fiber array module 1′ is directly coupled to the photoelectric detector. For example, as shown in FIG. 2, there is a gap between the optical fiber array module 1′ and the photoelectric detector, and the transmittance of the optical signal is lost by about 4% due to the interface between the optical fiber array module 1′ and the air. In Embodiment 1 of the present disclosure, the lens module 2 can be connected to the base 11 using an adhesive 5. As shown in FIGS. 3 and 6, the lens module 2 can be stably fixed to the base 11 with the adhesive 5 to ensure that the distance between the lens module 2 and the optical fiber 14 will not change, which is beneficial to ensure the stable transmission of the optical signal, and the adhesive 5 can eliminate the gap between the lens module 2 and the base 11. Thus, the problem of transmittance loss of the optical signal caused by the interface between the optical fiber array module 1 and the air is avoided, and the transmittance of the optical signal is improved. In certain implementations, the adhesive 5 may be preferably a refractive index matching adhesive.

### Embodiment 2

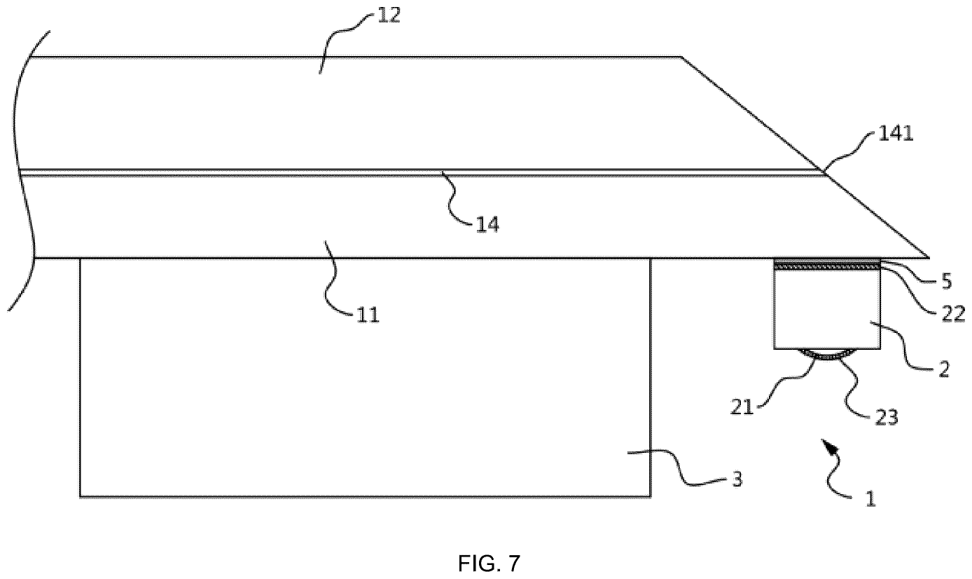

As the adhesive 5 fills the gap between the base 11 and the lens module 2, when the refractive index of the adhesive 5 is quite different (e.g., by >7-10%) from that of the lens module 2, the light transmission efficiency at the interface between the adhesive 5 and the lens module 2 may be reduced. Especially when the lens module 2 comprises a silicone, the refractive index of the lens module 2 is relatively large, and when the difference between the refractive index of the adhesive 5 and the refractive index of the lens module 2 is relatively large, the light transmission efficiency may be seriously affected. In order to solve this technical problem, the main difference between the present Embodiment 2 and the above Embodiment 1 is that in the present embodiment, the light entrance surface of the lens module 2 facing the base 11 includes a first anti-reflection film 22, as shown in FIG. 7. The first anti-reflection film 22 is deposited or otherwise formed on the light entrance surface of the lens module 2, and the adhesive 5 is between it and the lens module 2. The first anti-reflection film 22 solves the problem in which the light transmission efficiency is reduced due to the refractive index difference between the adhesive 5 and the lens module 2, and effectively improve the transmittance and the light transmission efficiency of the optical signal.

Similarly, when there is a sufficiently large difference between the refractive index of the lens module 2 and the refractive index of the air, the light transmission efficiency at the interface between the lens module 2 and the air may be greatly reduced. Especially when the lens module 2 comprises a silicone, the refractive index of the lens module 2 is large relative to that of air, and the difference between the refractive index of the air and the refractive index of the lens module 2 may seriously affect the light transmission efficiency. In order to solve this technical problem, in a further example, the surface of the lens module 2 that faces away from the base 11 and through which light exits is a light-emitting surface (including the spherical surface 21) that includes a second anti-reflection film 23, as shown in FIG. 7. The second anti-reflection film 23 is deposited or otherwise formed on the light-emitting surface 21 of the lens module 2, and is between the lens module 2 and the air. Therefore, the second anti-reflection film 23 can solve the problem of a reduction in the light transmission efficiency due to the refractive index difference between the lens module 2 and the air, and can improve the transmittance and the light transmission efficiency of the optical signal.

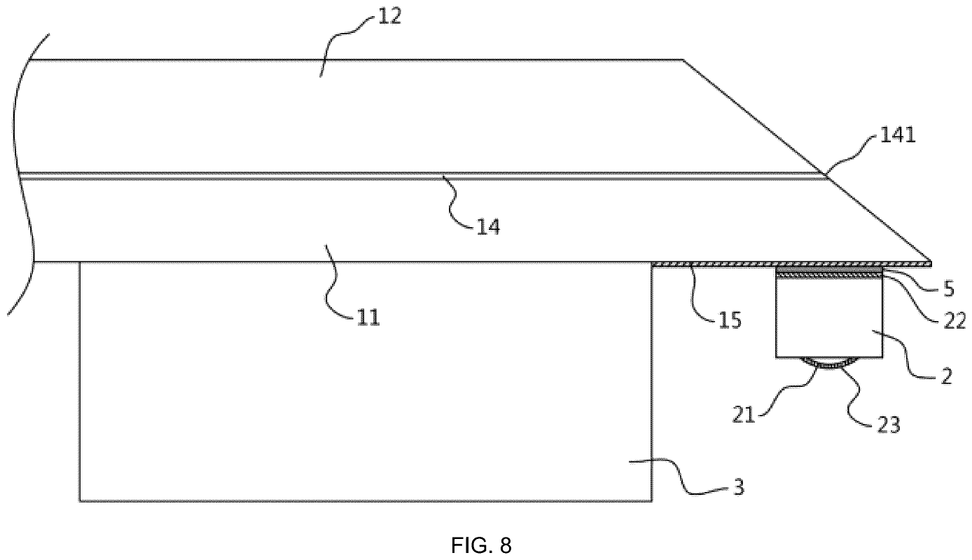

In a further example, the surface of the base 11 facing the lens module 2 can also include a third anti-reflection film 15, as shown in FIG. 8. The third anti-reflection film 15 is deposited or otherwise formed on the surface of the base 11, and the adhesive 5 may be deposited on the third anti-reflection film 15 and/or the first anti-reflection film 22 to secure or affix the lens module 2 to the base 11. Therefore, the third anti-reflection film 15 can solve the problem of reduced light transmission efficiency is due to the difference in refractive index between the base 11 and the adhesive 5, and can improve the transmittance and the light transmission efficiency of the optical signal.

### Embodiment 3

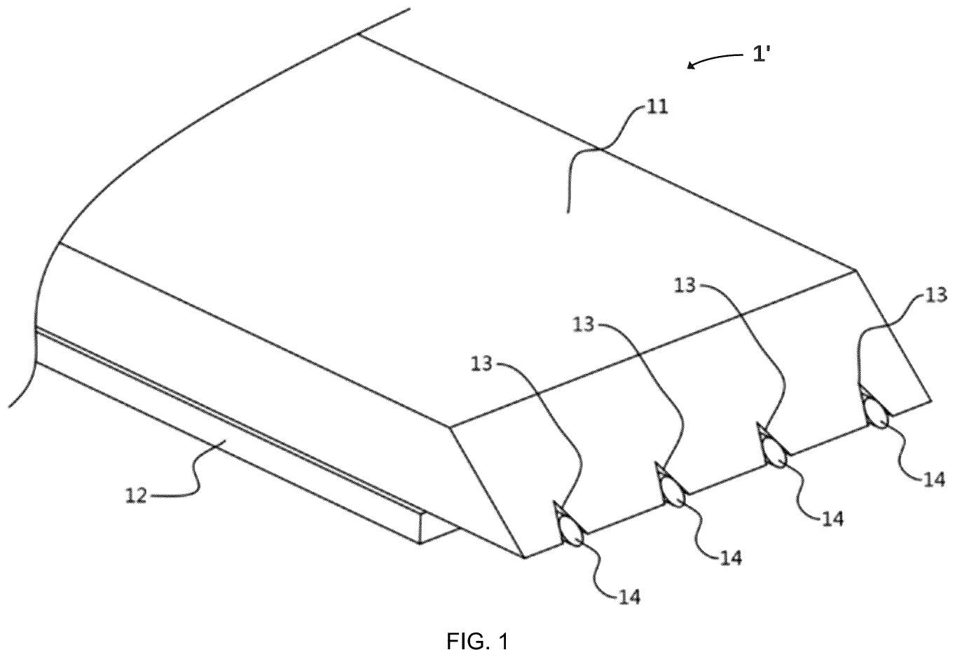

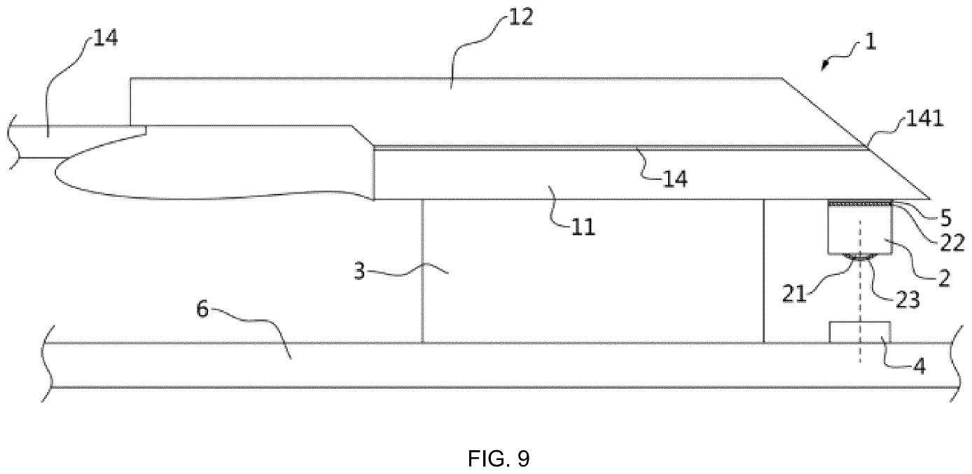

This embodiment provides a signal receiving structure mainly configured to convert an optical signal into an electrical signal. In this embodiment, the signal receiving structure includes a light receiving chip 4, a supporting component 6, and the optical fiber array assembly in Embodiment 1 or Embodiment 2, wherein the light receiving chip 4 is mainly used for receiving optical signals and converting the optical signals into corresponding electrical signals. As shown in FIG. 9, the light receiving chip 4 is mounted on or affixed to the supporting component 6, and the light receiving chip 4 is positioned below and/or corresponding to the lens module 2. There is an interval or space between the lens module 2 and the light receiving chip 4, and the interval or space can be much larger than the gap between the optical fiber array module 1′ and the light receiving chip 4 in FIGS. 1-2, so that the light beam can more gradually converge or focus on the light receiving chip 4 after passing through the lens module 2. This can greatly reduce the diameter of the light spot impinging on the light receiving chip 4, which can further improve the coupling efficiency increase or widen the coupling position window of the optical fiber array module 1 for all channels, achieve high coupling efficiency, and effectively reduce process difficulty. At the same time, in the assembly process, on the one hand, the light receiving chip 4 does not directly contact the lens module 2, and the light receiving chip 4 is also relatively distant from the optical fiber 14, which greatly reduces the probability of collision between the optical fiber array module 1 and the photoelectric detection and effectively improves the product yield. On the other hand, it is not necessary to determine and control the position of the optical fiber array module 1 through clear image recognition, which simplifies the process.

In various implementations, the distance between the lens module 2 and the optical fiber 14 may preferentially be from 0.1 mm to about 2 mm (for example, 0.3 mm, 0.36 mm, 0.4 mm, 0.5 mm, 0.6 mm and the like), which is beneficial to achieve a better effect.

In order to accurately control the distance between the lens module 2 and the light-receiving chip 4, in typical implementations, the optical fiber array assembly further includes a cushion block 3. As shown in FIG. 9, the cushion block 3 is under the base 11 and/or between the base 11 and the supporting member 6. The base 11 can be connected to the cushion block 3 using an adhesive (e.g., a non-refractive index matching adhesive), and the cushion block 3 can be on the supporting member 6. The cushion block 3 stably supports the optical fiber array assembly. Moreover, the optical fiber array assembly and the light receiving chip 4 are both on the same supporting member 6, and the lens module 2 is suspended from the base 11, as shown in FIG. 9, so as to be spaced apart from the light receiving chip 4. In various implementations, the cushion or spacer block 3 has a set or predetermined thickness, so that the spacing between the lens module 2 and the light receiving chip 4 is controlled and ensured by the thickness of the cushion or spacer block 3, which ensures that the spacing between the lens module 2 and the light receiving chip 4 can meet specifications and/or design requirements, in turn reducing the size of the light spot focused on the light receiving chip 4 via the lens module 2, and facilitating higher coupling efficiency.

In various implementations, the thickness of the cushion block 3 may be preferably 0.3 mm to 2.15 mm (for example, 0.7 mm, 0.8 mm, 0.9 mm, 1.0 mm, 1.1 mm and the like), which is conducive to achieving a better effect.

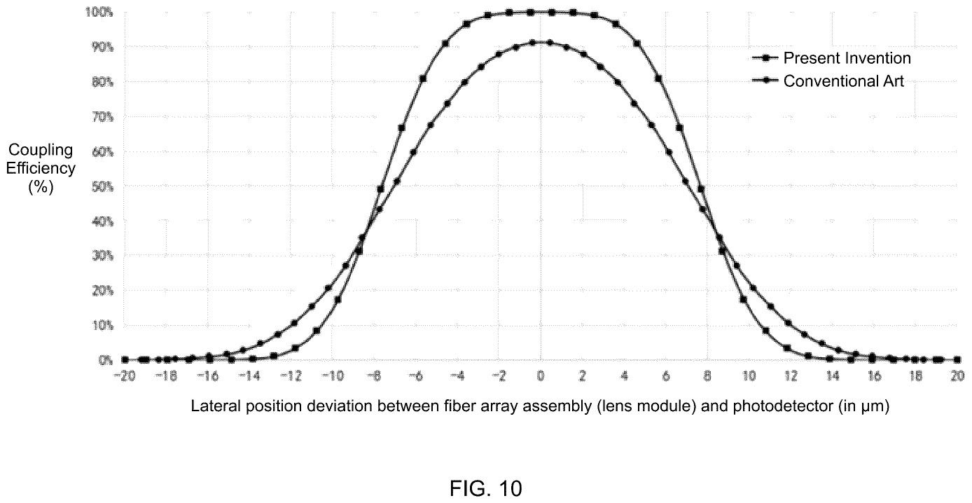

In the present disclosure, the coupling position window of the optical fiber array module 1 may refer to: when the optical fiber array module 1 and the light receiving chip 4 are assembled (or at least positioned on the supporting member 6), the maximum lateral position deviation between the optical fiber array module 1 (or the lens module 2) and the light receiving core 4 that can be allowed (which can be understood as coaxiality; refer to the dotted arrows in FIG. 6). When the lateral position deviation between the optical fiber array module 1 (or the lens module 2) and the light receiving chip 4 is larger than the maximum allowed lateral position deviation (that is, the lens module 2 of the optical fiber array module 1 and the light receiving chip 4 are more misaligned), the coupling efficiency is relatively low, and may be insufficient. Based on this, the coupling position window of the optical fiber array module 1 that enables all channels to achieve sufficiently high coupling efficiency refers to the maximum allowable lateral position deviation between the optical fiber array module 1 (or the lens module 2) and the light receiving chip 4 (e.g., in the case of ensuring that all channels can achieve acceptably high coupling efficiency). For example, as shown in FIG. 10, the coupling efficiency as a function of the lateral position deviation between the optical fiber array assembly (or lens module 2) and the photodetector 4 provided by an example of the present invention is greatly improved in comparison with the coupling scheme of the conventional art (e.g., FIGS. 1-2). First, a simulation of the maximum coupling efficiency of the conventional art is only about 90%, while the coupling efficiency provided by the present invention is significantly higher (i.e., the same simulation results in a coupling efficiency close to 100%). In the conventional scheme, a 90% coupling efficiency is achieved only when the optical fiber array module 1′ and the light receiving chip 4 are within a maximum lateral position deviation of +1 μm (i.e., the coupling position window providing a minimum of 90% coupling efficiency is +1 μm). As shown in FIG. 10, the coupling efficiency provided by the present invention is higher than 95% when the maximum lateral position deviation between the optical fiber array module 1 and the receiving chip 4 is +4 μm (i.e., the coupling position window providing a minimum of 95% coupling efficiency is +4 μm). When ensuring a coupling efficiency close to 100%, the maximum allowable lateral position deviation between the optical fiber array module 1 and the light receiving chip 4 in the present invention is +1.5 μm. Therefore, the coupling position window of the optical fiber array module 1 that enables all channels to achieve high coupling efficiency is significantly wider in the present invention when compared to the conventional art (e.g., FIGS. 1-2).

In this embodiment, the supporting component 6 may comprise a PCB board, a mechanical substrate, or the like; and the light receiving chip 4 may comprise a photodetector configured to receive one or more (typically one) of the optical signals from the optical fiber array module 1.

In a further embodiment, the signal receiving structure may further include a transimpedance amplifier (TIA, which may be in the form of an integrated circuit or chip), electrically connected to the light receiving chip 4. The TIA may also be mounted on or affixed to the supporting component 6.

### Embodiment 4

This embodiment provides an optical module, including the optical fiber array assembly in Embodiment 1 or Embodiment 2, or the optical signal receiving structure in Embodiment 3.

In one or more implementations, the optical module further includes a housing providing an assembly space, and the optical fiber array assembly or the optical signal receiving structure may be in the assembly space. In some implementations, the housing may include a housing base and a top plate. The top plate is attachable to and detachable from the housing base, and the assembly space is between the top plate and the housing base when attached.

In other or further implementations, the optical module further includes an optical fiber interface at one end of the housing. The optical fibers 14 may pass through the optical fiber interface into the optical fiber array assembly, so that received optical signals are transmitted to the optical signal receiving chip 4 in the optical module through the optical fiber interface.

### Embodiment 5

This embodiment provides a coupling method to make it easier for all channels to achieve acceptably high coupling efficiency, including a design stage and/or an assembly stage. The design stage may include: (1) determining the lens module 2 focal length F, specifically according to the lens module 2 material, lens shape and size, and optionally other parameters;
(2) Determining (e.g., calculating) a thickness D1 of the base 11 according to the focal length F of the lens module 2. In practice, the thickness D1 may preferably be from 0.1 mm to 1.2 mm (for example, 0.3 mm, 0.4 mm, 0.5 mm, 0.6 mm, etc.).
(3) Determining a spacing L between the lens module 2 and the light-receiving chip 4 according to the focal length F of the lens module 2 and the thickness D1 of the base 11. In implementation, the spacing L may be preferably from 0.1 mm to 2 mm (for example, 0.3 mm, 0.36 mm, 0.4 mm, 0.5 mm, 0.6 mm, etc.). (4) Determining a thickness D2 of the spacer (e.g., cushion block) 3 according to the distance L between the lens module 2 and the light receiving chip 4. In implementation, the thickness D2 may be preferably from 0.3 mm to 2.15 mm (for example, 0.7 mm, 0.8 mm, 0.9 mm, 1.0 mm, 1.1 mm, etc.).

The assembly stage may include: arranging the optical fibers 14 and the lens module 2 on opposite sides of the base 11, where the lens module 2 is in a position corresponding to the ends of the optical fibers 14; connecting the cushion block or spacer 3 to the base 11, such that the cushion block 3 and the lens module 2 are on the same side of the base 11; arranging the light receiving chip(s) 4 and the cushion block 3 on the supporting member 6, such that the lens module 2 corresponds to (e.g., focuses the optical signals on) the light receiving chip(s) 4. In this manner, the coupling between the optical fibers 14 and the light receiving chip(s) 4 is completed. This coupling method provides a higher coupling efficiency (e.g., than the conventional scheme), greatly reduces the probability of collision between the light receiving chip(s) 4 and the optical fiber(s) 14, and effectively improves the product yield. The coupling method is applicable to the above optical fiber array assembly, optical signal receiving structure and optical module, which can increase the range of the coupling position window of the optical fiber array module 1 while ensuring higher coupling efficiency, and it is easier to achieve high coupling efficiency in the process of construction and assembly, while greatly reducing the difficulty of the process.

The foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to best explain the principles of the invention and its practical application, to thereby enable others skilled in the art to best utilize the invention and various embodiments with various modifications as are suited to the particular use contemplated.

What is claimed is:

1. An optical fiber array assembly, comprising an optical fiber array module and a lens module, wherein:
the optical fiber array module comprises a base and at least two optical fibers on one side of the base in an array, and each of the optical fibers has an end configured as an inclined plane;
the lens module is on an opposite side of the base in a location corresponding to the ends of the optical fiber,
the optical signals transmitted through the optical fibers are reflected by the ends of the optical fibers through the base and into the lens module, and
the lens module is configured to focus the optical signals on one or more light receiving chips.

2. The optical fiber array assembly according to claim 1, further comprising an adhesive connecting the lens module to the base.

3. The optical fiber array assembly according to claim 2, wherein the adhesive comprises a refractive index matching adhesive.

4. The optical fiber array assembly according to claim 1, wherein the lens module has a light-receiving surface facing the base, and the light-receiving surface includes a first anti-reflection film.

5. The optical fiber array assembly according to claim 1, wherein the lens module has a light-emitting surface away from the base, and the light-emitting surface includes a second anti-reflection film.

6. The optical fiber array assembly according to claim 1, wherein the base has a thickness of 0.1 mm to 1.2 mm.

7. The optical fiber array assembly according to claim 1, wherein the lens module comprises a silicon material.

8. The optical fiber array assembly according to claim 1, wherein the optical fiber array module further comprises a cover plate connected to the base, and the optical fibers are sandwiched between the cover plate and the base.

9. The optical fiber array assembly according to claim 8, wherein the cover plate or the base is configured with at least two grooves that accommodate the optical fibers, the optical fibers are in the grooves, and the optical fiber array assembly further comprises a refractive index matching adhesive in the grooves, between each of the optical fibers and the cover plate or the base.

10. The optical fiber array assembly according to claim 9, wherein the groove has a V shape; the base has one end with a first inclined surface; and the cover has one end with a second inclined surface.

11. The optical fiber array assembly according to claim 1, further comprising a cushion block or spacer connected to the base, wherein the cushion block or spacer and the lens module are on a same side of the base, and a distance between the lens module and the light receiving chip is controlled by the cushion block.

12. The optical fiber array assembly according to claim 11, further comprising an adhesive connecting the cushion block or spacer to the base.

13. A signal receiving structure, comprising
a supporting component,
the optical fiber array assembly according to claim 1, and
the one or more light receiving chips, wherein:
the one or more light receiving chips are on the supporting component,
the one or more light receiving chips correspond to the location of the lens module, and
a spacing is between the lens module and the one or more light receiving chips.

14. The signal receiving structure according to claim 13, wherein the distance between the lens module and the one or more light receiving chips is 0.1 mm-2 mm.

15. The signal receiving structure according to claim 13, further comprising a cushion block or spacer supporting the base and on the supporting component, wherein a distance between the lens module and the one or more light receiving chips is controlled by the cushion block or spacer.

16. The signal receiving structure according to claim 15, further comprising an adhesive connecting the cushion block or spacer to the base.

17. The signal receiving structure according to claim 15, wherein the cushion block or spacer has a thickness of 0.3 mm to 2.15 mm.

18. The signal receiving structure according to claim 15, wherein each of the one or more light receiving chips comprises a photodetector, and the supporting component comprises a PCB board or a mechanical substrate.

19. An optical module, comprising the optical fiber array assembly according to claim 1.

20. The optical module according to claim 19, further comprising a housing providing an assembly space, and the optical fiber array assembly or the optical signal receiving structure is in the assembly space; and an optical fiber interface at one end of the housing, wherein the optical fibers connect to the optical fiber array assembly through the optical fiber interface.
